(19) United States
(12) Patent Application Publication
(10) Pub. No.: US 2023/0178999 A1
(43) Pub. Date: Jun. 8, 2023

(54) BATTERY CHARGING SYSTEM

(71) Applicant: Il-hong MIN, Seoul (KR)

(72) Inventor: Il-hong MIN, Seoul (KR)

(21) Appl. No.: 17/921,575

(22) PCT Filed: Nov. 12, 2020
(86) PCT No.: PCT/KR2020/015865

§ 371 Date: Oct. 26, 2022

(30) Foreign Application Priority Data
May 22, 2020 (KR) 10-2020-0061932

(51) Int. Cl. H02J 7/00

(52) U.S. Cl. CPC H02J 7/0013; H02J 7/0045

(57) ABSTRACT

Disclosed is a battery charging system according to an embodiment present invention including a battery module having a plurality of rechargeable batteries, and a charger connected to the battery module for charging, wherein when the battery module and the charger are connected, the plurality of rechargeable batteries are disconnected from each other to receive external power separately from the charger, thereby reducing the charging time of the battery module.

### TECHNICAL FIELD

The present invention relates to a battery charging system, and more particularly, to the battery charging system capable of reducing a charging time by individually charging a rechargeable battery included in a battery module.

### BACKGROUND ART

Due to global warming, carbon dioxide emissions are being restricted. Accordingly, the use of internal combustion engines using fossil fuels is gradually decreasing, and motors that emit no carbon dioxide when operating are replacing the internal combustion engines.

The motor receives power from a battery provided on one side of the motor. The battery requires recharging when discharged and currently consumes approximately 40 minutes to complete charging of the battery. The charging time of the battery is relatively longer than that of the replenishing time of fossil fuels.

### DISCLOSURE

### Technical Problem

Therefore, the present invention has been made in view of the above problems, and it is an object of the present invention to provide a battery charging system that can reduce the charging time of the battery.

### Technical Solution

To accomplish the above objects, according to one aspect of the present invention, there is provided a battery charging system according to an embodiment present invention including a battery module having a plurality of rechargeable batteries, and a charger connected to the battery module for charging, wherein when the battery module and the charger are connected, the plurality of rechargeable batteries are disconnected from each other to receive external power separately from the charger.

In addition, the battery module may include a supply line connected to a plurality of rechargeable batteries in series, a charging port connected to the charger, and a plurality of charging lines extended to the plurality of rechargeable batteries from the charging port.

In addition, the supply line may be provided with a plurality of disconnection switches for disconnecting the plurality of rechargeable batteries from each other, and in each of the plurality of charging lines, a connection switch is provided, which allows current to flow to the rechargeable battery.

In addition, the battery module may further include a bypass line maintaining an electric connection of a power drive device with the battery module when the battery module is connected to the charger, wherein the bypass line may be provided with a bypass rechargeable battery.

In addition, the charging port is provided with a plurality of charging terminals connected to any one end of the plurality of charging lines, and the charger includes a charging plug engaged to the charging port, wherein the charging plug is provided with a plurality of charging tips connected to any one of the plurality of charging terminals.

In addition, the charging port may be formed in a cup shape, and the charging plug may be formed in a column shape.

In addition, the charger may further include a lifting device that allows the plurality of charging tips to protrude toward the plurality of charging terminals while the charging plug is inserted into the charging port.

In addition, the lifting device includes a chamber formed inside the charging plug and a compressor that injects the gas towards the chamber, wherein when the chamber is filled with the gas by operating the compressor, the charging tip from the chamber may be protruded toward the surface of the charging plug.

### Advantageous Effects

According to the battery charging system of an embodiment of the present invention, as described above, the plurality of rechargeable batteries provided in the battery module is charged separately so that the charging time of the battery module may be reduced.

It is because the charging time required for the rechargeable battery to be fully charged is shorter than the time required for a general battery module with a larger capacity to be fully charged compared to the rechargeable battery.

### DESCRIPTION OF DRAWINGS

FIG. 1 shows an example of a battery charging system of an embodiment of the present invention.

FIG. 2 is a diagram showing an example of a charger in FIG. 1.

### MODE FOR INVENTION

Hereinafter, a battery charging system of an embodiment of the present invention will be described with reference to the accompanying drawings.

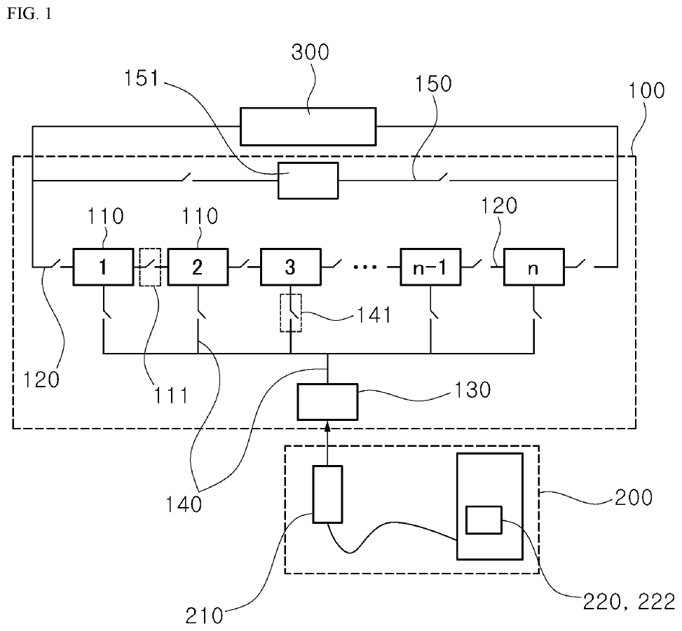

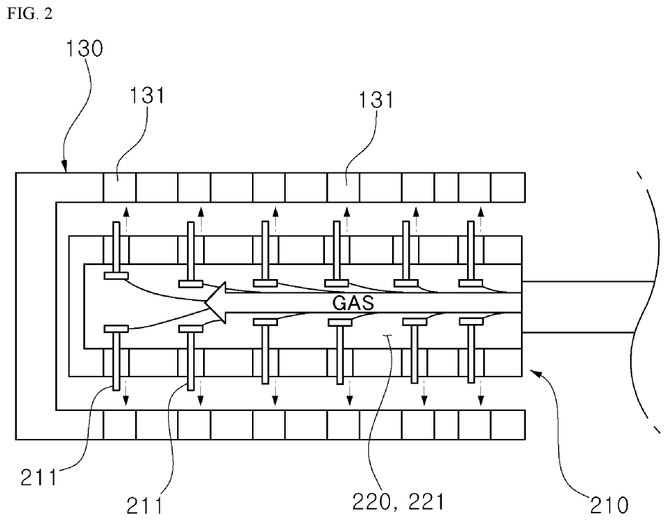

As shown in FIGS. 1 and 2, a battery charging system according to an embodiment of the present invention includes a battery module 100 having a plurality of rechargeable batteries 110, and a charger 200 connected to the battery module 100 for charging. When the battery module 100 and the charger 200 are connected, the plurality of rechargeable batteries 110 are disconnected from each other to receive external power separately from the charger 200.

Each rechargeable battery 110 is charged separately so that the amount of charging is reduced compared to the battery module 100 being charged at once, and the charging time is also reduced. All the rechargeable batteries 110 are charged simultaneously, and as a result, the total charging time of the battery module 100 is reduced.

The battery module 100 includes a supply line 120 connected to a plurality of rechargeable batteries 110 in series, a charging port 130 connected to the charger 200, and a plurality of charging lines 140 extended to the plurality of rechargeable batteries 110 from the charging port 130.

The supply line 120 is provided with a plurality of disconnection switches 111 for disconnecting the plurality of rechargeable batteries 110 from each other. In each of the plurality of charging lines 140, a connection switch 141 is provided, which allows current to flow to the rechargeable battery 110, and the charger 200.

The battery module 100 further includes a bypass line 150 maintaining an electric connection of a power drive device 300 with the battery module 100 when the battery module 100 is connected to the charger 200. The bypass line 150 is provided with a bypass rechargeable battery 151. The bypass rechargeable battery 151 supplies standby power of the power drive device 300 that receives power from the battery module 100 during charging.

The bypass line 150 is provided with a control switch. The control switch, the disconnection switch 111, and the connection switch 141 are operated by receiving a signal from a battery controller that controls the battery module 100. The battery controller is configured to: sense a connection between the battery module 100 and the charger 200, operate the control switch to close when the battery module 100 and the charger 200 are connected, operate the disconnection switch 111 to open, and the connection switch 141 to close. Accordingly, the power drive device 300 provides the power from the bypass rechargeable battery 151, the rechargeable battery 110 is disconnected from the power drive device 300, and connected to the charger 200.

The charging port 130 is provided with a plurality of charging terminals 131 connected to any one end of the plurality of charging lines 140. The charger 200 includes a charging plug 210 engaged to the charging port 130. The charging plug 210 is provided with a plurality of charging tips 211 connected to any one of the plurality of charging terminals 131.

The charging port 130 is formed in a cup shape, and a charging plug 210 is formed in a column shape. The charging plug 210 may be formed in a hexagonal prism or a triangular prism. The cross section of the charging port 130 may be a triangle or a hexagon depending on the shape of the charging plug 210.

The charger 200 may further include a lifting device 220 that allows the plurality of charging tips 211 to protrude toward the plurality of charging terminals 131 while the charging plug 210 is inserted into the charging port 130.

The lifting device 220 includes a chamber 221 formed inside the charging plug 210 and a compressor 222 that injects the gas towards the chamber 221. When the chamber 221 is filled with the gas by operating the compressor 222, the charging tip 211 from the chamber 221 is protruded toward the surface of the charging plug 210 so that the charging tip 211 is in a close contact with the charging terminal 131 or engaged with the charging terminal 131.

After completing the charging, the charging tip 211 is provided with a magnet or a return spring so that the charging tip 211 is separated from the charging terminal 131.

According to the battery charging system of an embodiment of the present invention, as described above, the plurality of rechargeable batteries 110 provided in the battery module 100 is charged separately so that the charging time of the battery module may be reduced.

It is because the charging time required for the rechargeable battery 110 to be fully charged is shorter than the time required for a general battery module 100 with a larger capacity to be fully charged compared to the rechargeable battery 110.

1. A battery charging system comprising:
a battery module including a plurality of rechargeable batteries; and
a charger connected to the battery module for charging,
wherein when the battery module and the charger are connected, the plurality of rechargeable batteries are disconnected from each other to receive external power separately from the charger.

2. The system of claim 1, wherein battery module comprising:
a supply line connected to a plurality of rechargeable batteries in series;
a charging port connected to the charger; and
a plurality of charging lines extended to the plurality of rechargeable batteries from the charging port.

3. The system of claim 2, wherein the supply line provided with a plurality of disconnection switches for disconnecting the plurality of rechargeable batteries from each other, and in each of the plurality of charging lines, a connection switch is provided, which allows current to flow to the rechargeable battery.

4. The system of claim 2, wherein the battery module further comprising a bypass line maintaining an electric connection of a power drive device with the battery module when the battery module is connected to the charger,
wherein the bypass line is provided with a bypass rechargeable battery.

5. The system of claim 2, wherein the charging port is provided with a plurality of charging terminals connected to any one end of the plurality of charging lines, and the charger includes a charging plug engaged to the charging port, wherein the charging plug is provided with a plurality of charging tips connected to any one of the plurality of charging terminals.

6. The system of claim 5, wherein the charging port is formed in a cup shape, and the charging plug is formed in a column shape.

7. The system of claim 6, wherein the charger further comprising a lifting device that allows the plurality of charging tips to protrude toward the plurality of charging terminals while the charging plug is inserted into the charging port.

8. The system of claim 7, wherein the lifting device comprising:
a chamber formed inside the charging plug; and
a compressor that injects the gas towards the chamber,
wherein when the chamber is filled with the gas by operating the compressor, the charging tip from the chamber is protruded toward the surface of the charging plug.
